(19) United States
(12) Patent Application Publication
(10) Pub. No.: US 2026/0284776 A1
(43) Pub. Date: Sep. 24, 2026

(54) MACHINE TOOL IMPLEMENTING A FRICTION STIR WELDING METHOD, WORKING METHOD THEREOF AND FRICTION STIR WELDING TOOL

(71) Applicant: COMAU FRANCE, TRAPPES (FR)

(72) Inventor: ROMAIN FONVIEILLE, CASTRES (FR)

(21) Appl. No.: 19/478,380

(22) PCT Filed: Apr. 25, 2024
(86) PCT No.: PCT/IB2024/054042

§ 371 Date: Oct. 24, 2025

(30) Foreign Application Priority Data
Apr. 26, 2023 (FR) 2304195

(51) Int. Cl. B23K 20/12

(52) U.S. Cl. CPC B23K 20/123; B23K 20/1225; B23K 20/1255

(57) ABSTRACT

The invention relates to a machining machine tool that accommodates and rotates a friction stir welding tool (500) with a first friction stir welding end (510) with a rotating pin (511) and a rotating shoulder (512), the force required to carry out a friction stir welding method being measured and maintained for the purpose of creating a force servo-control during the contact between the tool (500) and the parts to be joined via the functionality of controlling and monitoring the force during a movement up to a fixed stop. The invention also relates to the working method and to the tool for carrying out friction stir welding operations.

### FIELD OF THE INVENTION

The present invention relates to the field of friction welding and in particular to the adaptations enabling a machining machine tool to implement such a method under the best conditions.

### PRIOR ART

The friction stir welding method, known as FSW, is a welding method which consists of joining two parts by bringing their surfaces into contact to a pasty state, thanks to a rotating tool specially designed for this purpose.

This tool conventionally comprises a shoulder and a coaxial pin which, when applied and rotated, locally bring parts to be joined into a pasty state. The tool is applied and rotates on the contact line between the two parts to be joined or by crossing the first thickness to weld it to the second for two superimposed parts.

This tool penetrates the softened materials and stirs them to intimately mix them.

The assembly is obtained by the progression of the rotating tool, which travels the desired contact line or trajectory.

It is understood that implementing this method requires the tool to exert a strong stress on the parts to be joined. This strong stress requires drive means and control means provided for this purpose.

The conventional drive means of machining machine tools are not sized or provided for this implementation. Likewise, the control means have not been considered to manage them. Thus, for example the axial force making it possible to obtain the right welding conditions must be controlled throughout the FSW method.

Yet, one of the problems resulting from this method resides in the presence of a residual burr on either side of the welded zone, a residual burr commonly called “flash”. This burr must be removed and the best industrial means to do so resides in machining, a method which conventionally controls the positions and not the forces.

Means for applying the FSW method exist in the prior art.

For example, document WO0002704 describes a machine with a gantry architecture with a control system for FSW welding comprising both a force and position control. The system's control mode switches between position control and force control based on control parameters for the force and position of the welding head with respect to the part.

There is also an FSW head such as described in FR3045426 which is designed to be integrated into a machining centre to transform it from machining centre to friction stir welding centre.

None of these means makes it possible to industrially machine the “flash” burr produced.

For example, in the case of a machine tool dedicated to FSW, the part obtained is transferred to another machine tool dedicated to machining.

In the case where the FSW head is designed to be integrated into a machining centre, it is proposed to manually mount a milling tool to be able to machine the burr. However, the limited rotation capacities of the dedicated head and the changeover time do not make it possible to effectively utilise this method for applications of the automotive or aeronautical type, which require industrial means to produce at a high rate.

Document US10016838 describes a friction stir welding tool which can be fixed to a spindle of a machine tool. It also describes a machine tool which can accommodate it, as well as the technical problem of temperature management. The proposed solution is a novel tool design comprising a cooling jacket. If the problem of the temperature is addressed, this document does not describe the problem of managing the forces and in particular of the force servo-controls linked to implementing an FSW method on a non-dedicated machine.

Document JP2020069563 describes a machine tool capable of performing welding machining and cutting machining in a machining zone, reducing a cycle time and suppressing the transfer of heat to a spindle and a bearing supporting the spindle, even if a multi-purpose tool holder is used. This document also has not identified the technical problem related force management and does not provide a solution.

Document US2011/079339 describes equipment for controlling the force of a friction stir welding spindle intended to be mounted on an orbital head which uses a coaxial sensor to measure the bearing force. The system comprises an added force sensor which measures the bearing force which is applied by means of an electric actuator.

These means are therefore not sufficient on their own to produce parts with friction stir welding completely, and to carry out machining operations under good industrial conditions.

### BRIEF DESCRIPTION OF THE INVENTION

As a result, the applicant has conducted research aiming to industrialise this welding method by utilising its advantages on large-scale production.

The way to do this is to combine FSW and machining with good performance in one single and same means, i.e. in one single and same machine tool. The advantages of integrating the FSW method in a machine tool or a machining centre are numerous, among these:
To preserve the significant production capacities of this means (thanks to its performance, its automatic tool changes, etc.),
To preserve a machining capacity with good features (in particular, the rotation speed of the spindle), and
To integrate an additional manufacturing method, namely FSW.

Implementing this combination, however encounters the antagonism of these two methods on numerous parameters, such as the axial forces, the temperature, the rotation speed, the forward speed, the radial forces, the servo-controls.

For example, the position servo-controls conventionally implemented in a machining machine tool do not make it possible to ensure the control of the forces required to carry out an FSW method.

The invention is based on a machining machine tool equipped with
a tool-holder spindle preformed with an imprint to accommodate a plurality of tools to be rotated along the axis of the spindle,
a part-holder module,
a sub-assembly for guiding and translating the spindle towards the part-holder module and/or the part-holder module towards the spindle along an axis parallel to the axis of the spindle,
a digital controller implementing, in particular, for said guiding and setting-in-motion subassembly, a position servo-controls, as well as a functionality of controlling and monitoring the force during a movement up to a fixed stop.

According to the invention, the machine tool is characterised in that it accommodates and rotates a friction stir welding tool comprising a first friction stir welding end with a pin and a shoulder and a second end with a mechanical interface adapted to said imprint of the spindle, the rotation drive rotating the pin and the shoulder,
the force required to carry out a friction stir welding method being measured and maintained during the contact between the tool and the parts to be joined via the functionality of controlling and monitoring the force during a movement up to a fixed stop to be modified, controlled and maintained facing a setpoint value such that force servo-control is created.

This machine tool is thus capable of performing friction stir welding (called FSW) and machining by switching from one to the other automatically and industrially without the intervention of an operator. This means is industrial and capable of producing in large volume, parts requiring friction welding and machining.

The applicant has succeeded in providing the digital controller managing the axis in question with a capacity to be force servo-controlled (and more in position, at least during the FSW phases) to apply the axial force required for friction welding. The different use of a known and available function of the digital controller, namely the so-called “stop docking” function, makes it possible to create force servo-control on said working axis, while this function is conventionally used to generate defined forces to lock parts or to dock mechanical reference points.

The novel use of such a digital control function for the purpose of implementing an FSW method is therefore particularly original.

The function of controlling and maintaining the axial force on a working axis of the machining machine tool (that parallel to the axis of rotation of the welding tool) makes it possible to obtain the correct force conditions to ensure friction stir welding when the FSW tool is installed.

In concrete terms, this function is implemented by giving, as the setpoint value of the force (known as the docking force in the scope of the stop docking functionality), the desired value for a force required to carry out an FSW method with a rotating shoulder and rotating pin.

The digital controller will thus maintain this force during this method phase, thus creating force servo-control on this axis.

The design of the machine thus makes it possible to switch from the FSW operation to the conventional machining operations, and vice versa, automatically without any manual intervention from the operator, hence the significant gain in productivity. This passage is implemented without the addition of hardware or functional module.

Thus, another aim of the invention resides in the working method of such a machining machine tool which proposes the machining and the FSW method and, according to the tool accommodated, to switch from position servo-control to force servo-control and vice versa. The method is described below.

According to another particularly advantageous feature of the invention, said imprint is that corresponding to the HSK standard. The mechanical interface equipping the tool thus corresponds to this standard.

More specifically, according to a preferred but non-limiting embodiment, said imprint is that corresponding to the HSK100 standard and the FSW tool is equipped with an interface of the same standard. This attachment allows for more force at the spindle bearings (compared with an HSK 63 attachment) and thus allows for greater longevity and higher forward speed at the FSW method. The advantage of preserving a standard spindle interface is to preserve the automatic tool change, tool magazine and automatic tool loading functions of the machining machine tool. The FSW tool can therefore be stored and made available in the standard machine tool magazine.

Another aim of the invention relates to the FSW tool which can be used by the machine tool of the invention in the method of the invention. Such a tool is described below.

According to another particularly advantageous feature of the invention, said subassembly for guiding and translating the spindle towards the part-holder module and/or the part-holder module towards the spindle along an axis parallel to the axis of the spindle comprises at least one linear motor.

Such a motorisation enables the “stop docking” functionalities of their programming. The linear motor technology makes it possible to read and servo-control the force on this axis with great accuracy, as the drive is direct. The “stop docking” function of the digital controller of these motors is utilised originally by the invention to carry out the welding by using it to force servo-control the axis (and more in position), this manoeuvre makes it possible to apply a constant axial force, required for the FSW method, for the docking phase and during the welding phase of the part.

This motorisation also offers the option during the welding phase, to use the digital control functions to limit the maximum force, therefore the motor current while working with the position setpoint, but limited by the maximum current.

In machining machine tool configurations with an orientable spindle of the type of that comprising:
a subassembly for guiding and translating the spindle towards the part-holder module and/or the part-holder module towards the spindle along an axis parallel to the axis of the spindle, and
a digital controller implementing, in particular, for said guiding and setting-in-motion subassembly, a position servo-controls, as well as a functionality of controlling and monitoring the force during a movement up to a fixed stop.

The spindle and the part-holder device will be oriented, such that the axis of rotation of the spindle is parallel to the axis of translational movement managed by said subassembly.

Thus, it is not necessary for all the movements of the logical structure associated with the spindle to be linear. The orientation of the spindle makes it possible to have the desired servo-control on the axis which proposes it.

As explained above, the invention also resides in the working method of a machining machine tool which takes up all or some of the features described above, and which is characterised in that it comprises the following operations:
Friction stir welding operation with force servo-control on the axis parallel to the axis of rotation of the tool, force servo-control created by utilising for this purpose, the functionality of controlling and monitoring the force during a movement up to a fixed stop,
Machining operation with position servo-control on the axis parallel to the axis of rotation of the tool.

More specifically:
During the FSW operation, there is force servo-control on the axis parallel to the axis of rotation of the tool and position servo-control for the other axes.

In addition, as explained above, the other axes (those perpendicular to the axis of rotation) defining the welding trajectory of the FSW tool can form the subject of a force measurement, but without force servo-control, as they are thus themselves fed-back in position.

During the machining operation, all the axes are fed-back in position.

The machining operations can be carried out for the purpose of machining the “flash” burr or any other machining.

It is understood that if the machine tool of the invention can implement such a method, a fleet of at least two machine tools according to the invention can implement a different method, where the machines are dedicated to an operation, i.e. one to the FSW operation and the other to the machining operations.

According to another particularly advantageous feature of the invention, the method is characterised in that the so-called FSW friction stir welding operation comprises the following steps:
installation of an FSW tool with a rotating shoulder and rotating pin in the spindle imprint,
rotating the FSW tool about its axis of rotation at a speed corresponding to that required for the FSW method,
approaching by translational movement and with position servo-control on the axis parallel to the axis of rotation of the FSW tool up to contact of the shoulder of the FSW tool with the zone to be welded,
abandoning of said position servo-control on the axis parallel to the axis of rotation of the FSW tool,
measuring and maintaining the force with creating force servo-control on the axis parallel to the axis of rotation of the FSW tool according to a setpoint corresponding to that required for the FSW method,
setting in motion the FSW tool and/or the parts along one or more axes perpendicular to the axis of rotation of the FSW tool for the purpose of carrying out the welding,
end of welding,
abandoning the force servo-control,
withdrawing by translational movement and with position servo-control on the axis parallel to the axis of rotation of the FSW tool up to the FSW tool being completely separated from the welded zone.

The monitoring of the force can also be carried out for the perpendicular axes, but it is not possible to thus obtain force servo-control, as the correct implementation of the method requires preserving position servo-control on these axes, to be able to achieve the desired welding trajectory.

To implement this force monitoring, according to another particularly advantageous feature of the invention, where the machine tool comprises a means of modulating the forward speed on its axes of setting in motion, the method comprises an operation of modulating the speed of movement along the axes of movement not subjected to the force servo-control of the method.

More specifically, according to another feature, the method consists, during welding, of modulating the speed of movement of the friction stir welding tool along the axes perpendicular to the axis of rotation of the friction stir welding tool to regulate the welding force to a programmed welding force setpoint. This modulation has the effect of regulating the welding force to a welding force setpoint programmed on these axes. This programming ensures a constant force, which makes it possible to have stable welding conditions and therefore, a good welding quality (homogeneity, continuity, etc.). This constant force also aims to avoid stalling the electric spindle or exceeding the admissible forces for the subassemblies contributing to the setting-in-motion along these axes. The axes are thus protected and their service life extended.

Learning is made possible and adaptation to different materials and thicknesses is also made possible.

To implement this modulation, in a machine tool comprising a means for measuring the current consumed by the setting-in-motion subassemblies along the axes perpendicular to the axis of rotation of the friction stir welding tool, the method consists, during the welding, of controlling the forces on the axes of movement not subjected to the force servo-control by measuring the current at the current control powering the setting-in-motion means, in order to not exceed a current corresponding to a force setpoint. The force on these perpendicular axes is therefore not servo-controlled directly (contrary to the stop docking), the position servo-control is well preserved to achieve the desired trajectory, but the speed is thus modulated in order to preserve a constant force on this axis during a phase, where it is not force servo-controlled. Synchronous action is referred to, as the forward speed of these axes is modulated according to the current measurement taken at the same time.

This is also a feature available in the management of the subassemblies of a machining machine tool, which is put at the service of the FSW method. The current measurement (which already exists) is used originally by creating the control function. Machining machine tools conventionally have several means for modulating the forward speed of the different subassemblies. The applicant wisely utilises this functionality for an optimisation of the FSW method.

This speed modulation can also be used for the translational movement along the axis parallel to the axis of rotation of the tool, in particular in the phases preceding the FSW welding phase itself.

Thus, according to another particularly advantageous feature of the invention, the operation of approaching by translational movement and with position servo-control on the axis parallel to the axis of rotation of the FSW tool, up to the shoulder of the tool comes into contact with the zone to be welded comprises the following operations:
controlling the forward speed of the axis parallel to the axis of rotation of the FSW tool up to contact of the pin of the tool with the zone to be welded, then
modulating the forward speed of the axis parallel to the axis of rotation of the FSW tool to regulate the fusion force at a programmed fusion force setpoint, up to contact of the shoulder of the tool with the zone to be welded.

The control is carried out according to a programmed speed, while the speed modulation is a speed regulation taking into account the measured value of the current by a synchronised current measurement action.

Such a method makes it possible to achieve a rapid forward motion, and adapted to the material and its thickness to optimise the duration of the approaching movements.

The applicant further noted that managing the temperature of the contact zone or those of the constituent elements subjected to the additional stresses constituted one of the technical problems to be resolved due to the antagonism of this management according to the method implemented. Indeed, the rise in temperature is sought and required at the tool/part contact zone for an FSW operation, while it is to be avoided for a machining operation and this, for at least two reasons: the machining quality and the service life of the machine tool components (in particular, the spindle).

According to a particularly advantageous feature of the invention, said friction stir welding tool for carrying out the friction stir welding operations described above, and comprising a first friction stir welding end with a pin and a shoulder and a second end with a mechanical interface, comprises a thermal insulator between the first end and the interface. Such a feature makes it possible to raise the temperature of the end of the tool more rapidly and avoids the temperature from rising too quickly at the spindle to protect its guide means.

More specifically, according to another particularly advantageous feature of the invention, said tool is preformed from a plurality of separate heat diffusion discs disposed between the first end and the interface.

According to another particularly advantageous feature of the invention, thermal insulation inserts are interposed between said discs.

These first features constitute solutions for thermal insulation implemented at the FSW tool.

In addition to the tool, the invention makes it possible to distribute the functionalities of the friction stir welding method in two members of the machining machine tool:
The subassembly for guiding and translating along an axis parallel to the axis of rotation of the tool and the electric spindle.
The spindle of the machine tool must have the features required for the FSW, in particular concerning the take-up of axial and radial forces, while preserving its machining capabilities.

It is thus understood that it is possible to implement an FSW method in existing machining machine tools by:
equipping it with an FSW tool,
changing the programming of the digital controller managing the subassembly for guiding and setting in motion on an axis parallel to the axis of rotation of said tool to create force servo-control,
changing the electric spindle (which is a subassembly which changes regularly) for an electric spindle capable of taking up the forces.

Since the basic concepts of the invention have been explained above in their most basic form, other details and features will become more clearly apparent upon reading the description below and with reference to the accompanying drawings, which give, as non-limiting example, several embodiments of the machine tool and/or its functional subassemblies according to the invention.

### BRIEF DESCRIPTION OF THE DRAWINGS

FIG. 1 is a schematic drawing of a top, perspective, partial view, illustrating a first embodiment of the machine tool according to the invention;

FIG. 2 is a schematic drawing of a top, perspective, partial view of another embodiment of a first machine tool according to the invention;

FIG. 3 is a schematic drawing of an external side view of an embodiment of an assembly formed by an electric spindle and a tool according to the invention;

FIG. 4 is a schematic drawing of an external view of an embodiment of a tool holder according to the invention;

FIG. 5 is a diagram illustrating an embodiment of managing servo-controls on the axis parallel to the axis of rotation of the tool according to the cycle times of an FSW method according to the invention;

FIG. 6 is a schematic drawing of a partial side, cross-sectional view illustrating the positions taken by the FSW tool with respect to two parts to be joined;

FIG. 7 is a schematic drawing of a partial front view illustrating the positions taken by the FSW tool with respect to two parts to be joined;

FIG. 8 is a schematic drawing of a partial side, cross-sectional view illustrating one of the positions taken by the FSW tool with respect to the two parts to be joined;

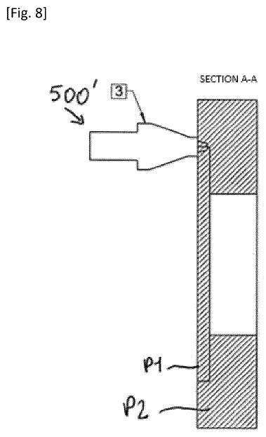

FIG. 9 is a diagram illustrating an embodiment of managing speed on the axes perpendicular to the axis of rotation of the tool according to the cycle times of an FSW method according to the invention;

FIG. 10 is a diagram illustrating an embodiment for managing the translation speeds on the axis parallel to the axis of rotation of the tool according to the cycle times of an FSW method according to the invention.

### DESCRIPTION OF PREFERRED EMBODIMENTS

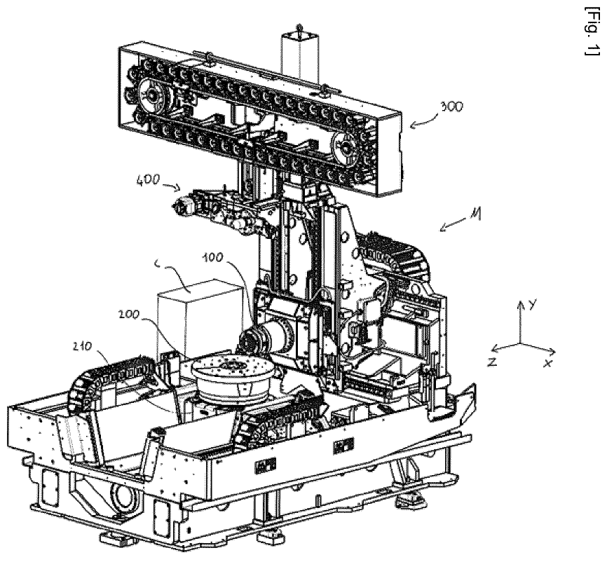

As illustrated in FIG. 1, the machine tool referenced M in its entirety is equipped with:
a tool holder electric spindle 100 preformed with an imprint to accommodate a plurality of tools to be rotated along the axis of the spindle, which is, in this case, parallel to the horizontal axis Z,
a part-holder module 200,
a subassembly 210 for guiding and translating parallel to the axis Z of the part-holder module 200 towards the spindle 100 along an axis parallel to the axis of the spindle,
a tool storage module 300,
a tool exchange module 400.

The electric spindle 100 is disposed in a sheath which is guided and translated along a vertical plane defined by the axes X and Y opposite the part-holder module 200 which is movable in translation perpendicularly to said plane. According to a preferred embodiment, the part-holder module is translated by means of linear motors.

The machine tool M comprises a digital controller C implementing, in particular, for said guiding and setting-in-motion subassembly 210, position servo-control, as well as a functionality of controlling and monitoring the force during a movement up to a fixed stop (stop docking function).

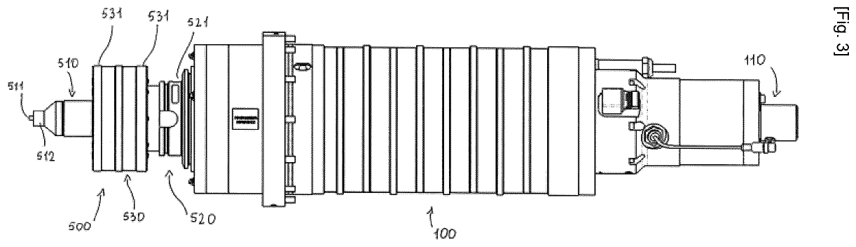

FIG. 3 illustrates the electric spindle 100 accommodating an embodiment of an FSW tool 500 according to the invention.

The electric spindle 100 is sized, so as to be capable of supporting the large forces implemented during the FSW operation. It accommodates and rotates the tool 500 parallel to the axis Z. By its rear end 110, it connects to power supply, control and optionally hydraulic power modules.

The friction stir welding tool 500 comprises two parts:
a first part forming the first end 510 with a pin 511 and a shoulder 512, and
a second part or tool holder 520 forming the second end with a mechanical interface 521 adapted to said imprint of the electric spindle. These two parts can be separated, in order to ensure the maintenance of the tool and to change the end 510 likely to wear.

According to the embodiment illustrated in this figure, said friction stir welding tool 500 comprises a thermal insulator 530 between the first end 510 and the interface 521. More specifically, the thermal insulator 530 consists of a plurality of discs 531 spaced apart for the purpose of diffusing the heat produced and therefore separating the electric spindle from the welding zone.

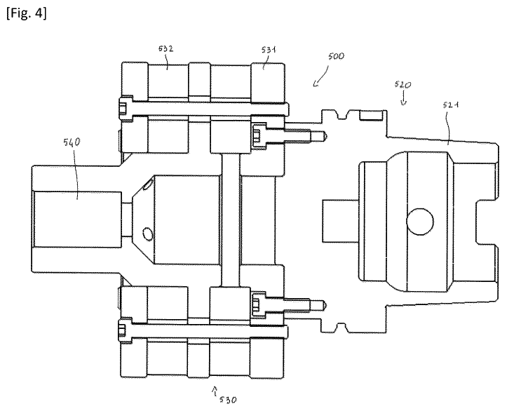

As illustrated more specifically in FIG. 4, the tool holder 520 which is formed by the friction stir welding tool 500 from which the first end 510 has been removed, comprises a central hub fixed by screwing to the interface 521 and preformed:
in the internal axial part, an axial recess 540 to accommodate the first end 510 of the tool 500 formed by the shoulder and the pin (not illustrated),
in the external peripheral part, radial projections forming discs 531 spaced apart and between which thermal insulating inserts 532 are interposed. For screw fixing purposes, the insulating inserts 532 are passed through by bores aligned with bores made in the discs 531. This assembly forms the thermal insulator 530 between the first end 510 of the tool 500 and the interface 521.

As illustrated, said tool 500 is equipped with a mechanical interface 521 corresponding to the HSK100 standard which enables it to be managed as a conventional tool by the tool storage module 300 and by the tool exchange module 400.

The insulating inserts are chosen from aluminosilicate—or sintered ceramic-type materials known for their insulating capacities.

Thus, according to a preferred but non-limiting embodiment, the material of the insulating inserts is selected from the following list:
thermal insulation comprising 90% mica and 10% resin,
thermal insulation comprising 55% fluorophlogopite and 45% borosilicate.

The other functions of the digital control machining machine tool, like the mechanism for loading the tools into the machine, the automatic tool changing mechanism, the tool magazine, the closed machining zone, the air treatment of this zone, etc. complete this machine M and make it an industrial means of manufacturing parts requiring FSW and machining.

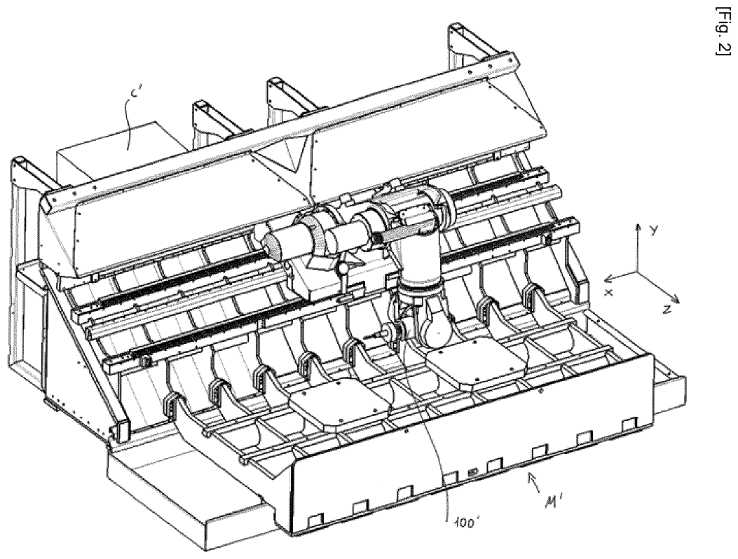

The machine tool M′ illustrated in FIG. 2 is also capable of integrating an FSW functionality according to the invention. Although the electric spindle 100′ is positioned and set in motion at the end of an arm-type articulated structure, the latter is secured to a carriage translating along the axis X. To implement the invention, said articulated structure will orient the electric spindle 100′ as illustrated, i.e. such that the axis of rotation of the electric spindle 100′ and therefore of the FSW tool that it carries during the FSW method is parallel to the axis X.

According to a preferred embodiment, the setting in motion of said carriage is carried out by linear motors.

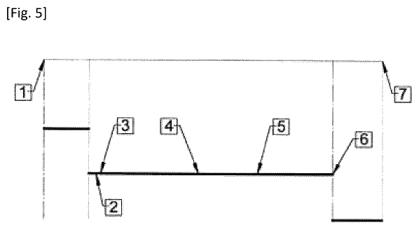

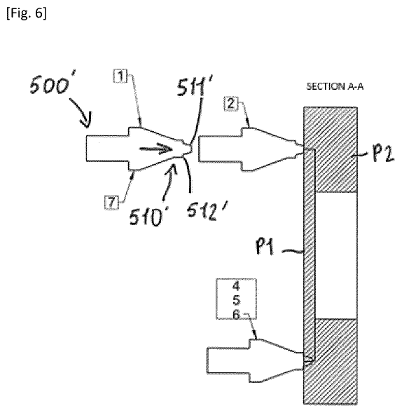

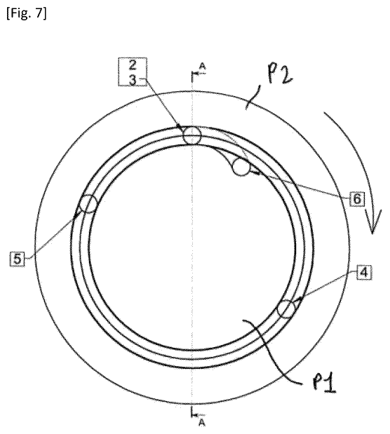

FIGS. 5 to 7 illustrate the implementation of the method of the invention on the circular parts P1 and P2 which must be welded together with a circular weld bead along the external peripheral edge of the part P.

The diagram of FIG. 5 illustrates the cycle times of the steps or phases numbered from 1 to 7 constituting the FSW operation itself. A machining can have taken place previously, and must take place afterwards for the machining of the so-called “flash” burr.

The tool 500′ comprises a first end 510′ formed by a rotating pin 511′ and a rotating shoulder 512′. It is installed in an electric spindle not illustrated in these figures.

The FSW tool 500′ is rotated at a speed corresponding to that required for the FSW method.

From 1 to 2, the logic structure associated with the electric spindle or that associated with the parts P1 and P2 ensures the moving closer of the tool and the parts by translational movement, and with position servo-control on the axis parallel to the axis of rotation of the FSW tool 500′ up to contact of the shoulder 512′ of the tool 500′ with the zone to be welded S.

In step 3, the pin 511′ has penetrated the material. In steps 1 and 7, the tool is moved away from the parts.

From step 2, the position servo-control on this translation is abandoned and replaced by the measurement and maintenance of the force with force servo-control according to a setpoint corresponding to that required for the FSW method. According to the invention, this is made possible, thanks to the functionality of controlling and monitoring the force during a movement up to a fixed stop, to which a setpoint has been fixed, corresponding to that of an FSW force and not that corresponding to a clamping stress or to a contact with a stop.

Steps 4, 5 and 6 see the setting in motion of the tool 500′ and/or of the parts P1 and P2 to be welded along one or more axes perpendicular to the axis of rotation of the FSW tool 500′ for the purpose of achieving the circular trajectory of the weld S.

Step 6 defines the end of the welding, the circular trajectory having again passed the tool 500′ over the start of the weld bead.

The force servo-control is abandoned in point 6. A withdrawal movement, by translational movement with position servo-control on the axis parallel to the axis of rotation of the FSW tool until the FSW tool 500′ is completely moved away from the welded zone S, finishes the method in step 7.

The FSW tool 500′ can thus be replaced with a machine tool to machine the burr created.

Then, with regard to the other functions to be ensured for the FSW, in particular the taking up of radial forces, the speed of rotation of the tool or the control of the temperature will be managed by the spindle member (the radial forces will also be taken up by the working axes of the machine used).

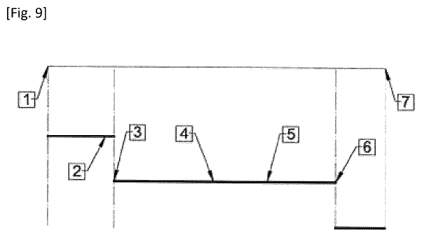

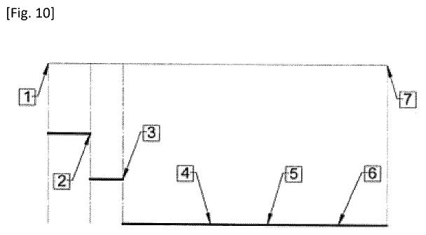

The diagrams of FIGS. 9 and 10 illustrate the speed management during the method.

FIG. 9 shows the management of the speed on the axes perpendicular to the axis of rotation of the tool according to the cycle times of an FSW method according to the invention, where:
during phases 1 to 2, the forward speed of the axes perpendicular to the axis of rotation of the tool is controlled by the digital control along a programmed trajectory and forward speed;
during phases 3 to 6, the programmed forward speed of the axes perpendicular to the axis of rotation of the tool is modulated to regulate the welding force according to a programmed welding force setpoint;
during phases 6 to 7, the forward speed of the axes perpendicular to the axis of rotation of the tool is again controlled by the digital control along a programmed trajectory and forward speed.

FIG. 10 shows the management of the translation speeds on the axis parallel to the axis of rotation of the tool according to the cycle times of an FSW method, where:
during phases 1 to 2, the forward speed along the axis parallel to the axis of rotation of the FSW tool is controlled by the digital control until the pin of the tool contacts the zone to be welded along a programmed trajectory and speed,
during phases 2 to 3, the forward speed along the axis parallel to the axis of rotation of the FSW tool is modulated to regulate the fusion force to a programmed fusion force setpoint up to contact of the shoulder of the tool with the zone to be welded,
during phases 3 to 7, given that the welding trajectory is located in a plane perpendicular to the axis of rotation of the tool, the speed of movement along the axis parallel to the axis of rotation of the FSW tool is controlled by the digital control up to the end of the welding, and even during the withdrawal movement of the tool.

It is understood that the device, which has just been described and represented above, has been so in view of a disclosure, rather than a limitation. Naturally, various arrangements, modifications, and improvements could be made to the above examples, without going beyond the scope of the invention.

1. A machining machine tool (M) equipped with
a tool-holder spindle (100) preformed with an imprint to accommodate a plurality of tools to be rotated along the axis of the spindle,
a part-holder module (200),
a subassembly (210) for guiding and translating the spindle towards the part-holder module and/or the part-holder module towards the spindle along an axis parallel to the axis of the spindle (100),
a digital controller (C) implementing, in particular, for said guiding and setting-in-motion subassembly (210), position servo-control as well as a functionality of controlling and monitoring the force during a movement up to a fixed stop,
CHARACTERISED IN THAT it accommodates and rotates a friction stir welding tool (500) comprising a first friction stir welding end (510) with a pin (511) and a shoulder (512) and a second end (520) with a mechanical interface (521) adapted to said imprint of the spindle (100), the rotation rotating the pin (511) and the shoulder (512),
the force required to carry out a friction stir welding method being measured and maintained for the purpose of creating a force servo-control during the contact between the tool (500) and the parts to be joined via the functionality of controlling and monitoring the force during a movement up to a fixed stop.

2. The machine tool (M) according to claim 1, comprising said subassembly (210) for guiding and translating the spindle (100) towards the part-holder module (200) and/or the part-holder module (200) towards the spindle (100) along an axis parallel to the axis of the spindle (100) comprises at least one linear motor.

3. The machine tool (M) according to claim 1, wherein said imprint corresponds to the HSK100 standard.

4. A method for working a machine tool (M) according to claim 1, CHARACTERISED IN THAT it comprises the following operations:
Friction stir welding operation with force servo-control on the axis parallel to the axis of rotation of the tool(500), force servo-control created by utilising for this purpose, the functionality of controlling and monitoring the force during a movement up to a fixed stop,
Machining operation with position servo-control on the axis parallel to the axis of rotation of the tool (500).

5. A method for working a machining machine tool (M) according to claim 1, CHARACTERISED IN THAT the friction stir welding operation comprises the following steps:
installing a friction stir welding tool (500′) with a rotating shoulder (512′) and a rotating pin (511′) in the imprint of the spindle (100′),
rotating the friction stir welding tool (500′) about its axis of rotation at a speed corresponding to that required for the friction stir welding method,
approaching by translational movement and with position servo-control on the axis parallel to the axis of rotation of the friction stir welding tool (500′) up to contact of the shoulder (512′) of the friction stir welding tool (500′) with the zone to be welded,
abandoning of said position servo-control on the axis parallel to the axis of rotation of the friction stir welding tool (500′),
measuring and maintaining the force with creating force servo-control on the axis parallel to the axis of rotation of the friction stir welding tool (500′) according to a setpoint corresponding to that required for the friction stir welding method,
setting in motion the friction stir welding tool (500′) and/or the zone to be welded along one or more axes perpendicular to the axis of rotation of the friction stir welding tool (500′) for the purpose of carrying out the welding,
end of welding,
abandoning the force servo-control,
withdrawing by translational movement and with position servo-control on the axis parallel to the axis of rotation of the FSW tool (500′) up to the FSW tool (500′) being completely separated from the welded zone.

6. The working method according to claim 5, where the machine tool comprises a means for modulating the forward speed on its axes of setting in motion, further including an operation of modulating the speed of movement along the axes of movement which is not subjected to the force servo-control.

7. The working method according to claim 6, wherein said method, during welding, of modulating the speed of movement of the friction stir welding tool (500′) along the axes perpendicular to the axis of rotation of the friction stir welding tool (500′) to regulate the welding force to a programmed welding force setpoint.

8. The working method according to claim 6, where the machine tool comprises a means for measuring the current consumed by the subassemblies moving along the axes perpendicular to the axis of rotation of the friction stir welding tool (500′), wherein said method, during welding, of controlling the forces on the axes of movement not subjected to the force servo-control by measuring the current at the current control powering the moving means so as not to exceed a current corresponding to a force setpoint.

9. The working method according to claim 5, wherein said method further includes an operation of controlling the speed of movement of the friction stir welding tool (500′) along the axis parallel to the axis of rotation of the friction stir welding tool (500′) outside of carrying out the welding.

10. The working method according to claim 5, wherein the operation of approaching by translational movement and with position servo-control on the axis parallel to the axis of rotation of the friction stir welding tool (500′) until the shoulder (512) of the friction stir welding tool (500′) comes into contact with the zone to be welded comprises the following operations:
controlling the forward speed of the axis parallel to the axis of rotation of the friction stir welding tool (500′) until contact of the pin (511′) of the friction stir welding tool (500′) with the zone to be welded, then
modulating the forward speed of the axis parallel to the axis of rotation of the friction stir welding tool (500′) to regulate the fusion force to a programmed fusion force setpoint until contact of the shoulder (512′) of the friction stir welding tool (500′) with the zone to be welded.

11. A friction stir welding tool (500) for carrying out the friction stir welding with the method of
Friction stir welding operation with force servo-control on the axis parallel to the axis of rotation of the tool(500), force servo-control created by utilising for this purpose, the functionality of controlling and monitoring the force during a movement up to a fixed stop,
Machining operation with position servo-control on the axis parallel to the axis of rotation of the tool (500) further including carrying out by the machine tool according to claim 1 and further comprising a first friction stir welding end (510) with a pin (511) and a shoulder (512) and a second end (520) with a mechanical interface (521), further including a thermal insulator (530) between the first end (510) and said interface (521).

12. The friction tool (500) according to claim 11, wherein said a step in said method is preformed from a plurality of separate heat diffusion discs (531) disposed between said first end (510) and said interface (521).

13. The friction tool (500) according to claim 12, wherein thermal insulating inserts (532) are interposed between said discs (531).

14. The friction stir welding tool (500) for carrying out the friction stir welding operations of the method according to claim 4 carried out by said machine tool (M) equipped with
a tool-holder spindle (100) preformed with an imprint to accommodate a plurality of tools to be rotated along the axis of the spindle,
a part-holder module (200),
a subassembly (210) for guiding and translating the spindle towards the part-holder module and/or the part-holder module towards the spindle along an axis parallel to the axis of the spindle (100),
a digital controller (C) implementing, in particular, for said guiding and setting-in-motion subassembly (210), position servo-control as well as a functionality of controlling and monitoring the force during a movement up to a fixed stop,
wherein said machine tool accommodates and rotates a friction stir welding tool (500) having a first friction stir welding end (510) with a pin (511) and a shoulder (512) and a second end (520) with a mechanical interface (521) adapted to said imprint of the spindle (100), the rotation rotating the pin (511) and the shoulder (512),
the force required to carry out a friction stir welding method being measured and maintained for the purpose of creating a force servo-control during the contact between the tool (500) and the parts to be joined via the functionality of controlling and monitoring the force during a movement up to a fixed stop and comprising a first friction stir welding end (510) with a pin (511) and a shoulder (512) and a second end (520) with a mechanical interface (521), and further including a thermal insulator (530) between the first end (510) and the interface (521).
